(19) United States
(12) Patent Application Publication
(10) Pub. No.: US 2024/0251993 A1
(43) Pub. Date: Aug. 1, 2024

(54) BRACKET ASSEMBLY, SYSTEM, AND METHOOD FOR HANGING A DECK GRILL

(71) Applicant: Barry Louis Goldfarb, Oak Ridge, NJ (US)

(72) Inventor: Barry Louis Goldfarb, Oak Ridge, NJ (US)

(21) Appl. No.: 18/425,121

(22) Filed: Jan. 29, 2024

Related U.S. Application Data
(60) Provisional application No. 63/481,913, filed on Jan. 27, 2023.

(51) Int. Cl. A47J 37/07; F16M 13/02

(52) U.S. Cl. CPC A47J 37/0786; F16M 13/02

(57) ABSTRACT

A bracket system for mounting a grill off a railing of the deck, so that the grill hangs off the railing, projecting beyond the perimeter or footprint of the deck, thereby eliminating clutter, and increasing deck space that can be used by guest and users of the deck, while allowing the grill to be accessible.

### CROSS-REFERENCE TO RELATED APPLICATION

This application claims the benefit of priority of U.S. provisional application No. 63/481,913, filed 27 Jan. 2023, the contents of which are herein incorporated by reference.

### BACKGROUND OF THE INVENTION

The present invention relates to outdoor grills and, more particularly, a grill bracket system for mounting a grill to a perimeter of the deck outside the railing.

It is common for people to host family and friends on their deck with the grilling of food as one of the main attractions. When there is limited space on a deck, however, the size of an outdoor grill can become a hinderance or at least a limitation on the deck space available to entertain family and friends. In other words, people typically utilize a barbeque grill as part of the enjoyable use of their deck; however, the presence of the grill one the deck clutters or at least limits the use of the whole square footage the deck for guests. This even more important for elevated decks where there is no adjacent backyard, or when the entire backyard is taken up by the deck.

As can be seen, there is a need for a bracket system for mounting a grill off a railing of the deck, so that the grill hangs off the railing, projecting beyond the perimeter or footprint of the deck, thereby eliminating clutter, and increasing deck space that can be used by guest and users of the deck, while allowing the grill to be accessible.

### SUMMARY OF THE INVENTION

In one aspect of the present invention, A method of hanging a grill off a railing of a deck, so that the grill hangs off the railing, projecting beyond a footprint of the deck, the method providing: connecting a main support arm to an underside of the deck so that a distal portion of the main support arm extends above and perpendicular relative to a decking of the deck; selectively connecting a grill support arm from the distal portion of the main support arm; adjusting a length of an adjustable crossbar that is joined to a distal end of the grill support arm, wherein the adjustable crossbar provides adjustable side bars extending from opposing ends of the adjustable crossbar, and wherein a respective grill leg extends perpendicularly from each end of the adjustable sidebars; and connecting the grill to the respective grill legs so that the grill projects above and beyond a footprint of the decking, wherein a gas tank bracket extends from the distal portion in a direction perpendicular to the grill support arm.

In another aspect of the present invention, a bracket system for hanging a grill off a railing of a deck, so that the grill hangs off the railing, projecting beyond a footprint of the deck, the bracket system provides the following: a main support arm extending between a proximal end and a distal portion wherein the proximal and distal portions are oriented perpendicular to each other; a grill support arm selectively sliding along the distal portion of the main support arm; an adjustable crossbar connected to a distal end of the grill support arm, wherein the adjustable crossbar has telescopic extendable crossbars, one telescopic extendable crossbar extending from each end thereof; an adjustable side bar connected to each distal end of each telescopic extendable crossbars, wherein each adjustable side bar has telescopic extendable side bars, one telescopic extendable side bar extending from each end thereof, wherein the adjustable side bar and adjustable crossbar are coplanar; and legs extend perpendicularly from each adjustable extendable side bars.

These and other features, aspects and advantages of the present invention will become better understood with reference to the following drawings, description and claims.

### BRIEF DESCRIPTION OF THE DRAWINGS

FIG. 1 is a front elevation view of an exemplary embodiment of grill legs 100 of the present invention. Each grill leg may be made of carbon steel or an equivalent resilient, strong, and durable material. Distance ‘a’ may be approximately 2.25 inches, though other dimensions are contemplated in different embodiments, wherein distance ‘a’ may vary by up to and over 100 percent. Distance ‘b’ may be approximately 1.5 inches, though other dimensions are contemplated in different embodiments, wherein distance ‘b’ may vary by up to and over 100 percent. Distance ‘c’ may be approximately 0.75 inches, though other dimensions are contemplated in different embodiments, wherein distance ‘c’ may vary by up to and over 100 percent. Distance ‘d’ may be approximately 5.75 inches, though other dimensions are contemplated in different embodiments, wherein distance ‘d’ may vary by up to and over 100 percent. Distance ‘f’ may be approximately 3.25 inches, though other dimensions are contemplated in different embodiments, wherein distance ‘f’ may vary by up to and over 100 percent. Distance ‘g’ may be approximately 0.25 inches, though other dimensions are contemplated in different embodiments, wherein distance ‘g’ may vary by up to and over 100 percent. Oblong slots 110 for may be provided for providing tolerance, wherein each oblong slot 110 is centered along the inner edge of a side bar 710/735.

FIG. 2 is a side elevation view of an exemplary embodiment of a grill support arm of the present invention, shown without side bars. A main arm 210 may be a 1.5×1.5×0.120 square tube made of carbon steel or an equivalent resilient, strong, and durable material. Distance ‘I’ of the main arm 210 may be approximately 16 inches, though other dimensions are contemplated in different embodiments, wherein distance ‘I’ may vary by up to and over 100 percent. Distance ‘h’ may be approximately 2.5 inches, though other dimensions are contemplated in different embodiments, wherein distance ‘h’ may vary by up to and over 100 percent. Distance ‘i’ may be approximately 2.0 inches, though other dimensions are contemplated in different embodiments, wherein distance ‘i’ may vary by up to and over 100 percent. Distance ‘j’ may be an approximately 0.5-inch opening/hole, though other dimensions are contemplated in different embodiments, wherein distance ‘j’ may vary by up to and over 100 percent. A fastener/nut 220 may connect a selectively adjustable collar connector to another orthogonal member of the system. A weld 2 may fixedly join components of the system.

FIG. 3A is a bottom elevation view of an exemplary embodiment of the grill legs 100 of the present invention. Distance ‘q’ may be approximately 1.75 inches, though other dimensions are contemplated in different embodiments, wherein distance ‘q’ may vary by up to and over 100 percent. Distance ‘r’ may be approximately 17.125 inches, though other dimensions are contemplated in different embodiments, wherein distance ‘r’ may vary by up to and over 100 percent.

FIG. 3B is a rear elevation view of an exemplary embodiment of the present invention illustrating a gas line mount 310. Distance ‘s’ may be approximately 0.74 inches, though other dimensions are contemplated in different embodiments, wherein distance ‘s’ may vary by up to and over 100 percent. Distance ‘t’ may be approximately 2.0 inches, though other dimensions are contemplated in different embodiments, wherein distance ‘t’ may vary by up to and over 100 percent.

FIG. 4A is a side elevation view of an exemplary embodiment of the present invention. Distance ‘n’ may be approximately 2.0 inches, though other dimensions are contemplated in different embodiments, wherein distance ‘n’ may vary by up to and over 100 percent.

FIG. 4B is a top plan view of an exemplary embodiment of a LPG tank bracket 450 of the present invention. Distance ‘u’ may be approximately the same as distance ‘h’. Distance ‘x’ may be approximately 9.0 inches, though other dimensions are contemplated in different embodiments, wherein distance ‘x’ may vary by up to and over 100 percent. The LPG tank bracket 450 may include a 1.5×0.871×28.3-inch carbon steel rolled to 9″ inner diameter band 460.

FIG. 4C is a front elevation view of an exemplary embodiment of the present invention. Distance ‘y’ may be approximately 9.375 inches, though other dimensions are contemplated in different embodiments, wherein distance ‘y’ may vary by up to and over 100 percent.

FIG. 5 is a right-side elevation view of an exemplary embodiment of the present invention. Distance ‘z’ may be approximately 0.875 inches, though other dimensions are contemplated in different embodiments, wherein distance ‘y’ may vary by up to and over 100 percent.

FIG. 6A is a top plan exploded view of an exemplary embodiment of a deck mounting bracket 600 the present invention, illustrating the operative association of the deck mounting bracket 600, a lock bolt 620 and the FIG. 6B is a top plan view of an exemplary embodiment of the present invention.

FIG. 7A is a top plan exploded view of an exemplary embodiment of the grill support arm 200 of the present invention, illustrating the crossbar 700 interconnecting two adjacent side bars 710. The crossbar 700 may have a distance ‘d′’ may be approximately 21.75 inches, though other dimensions are contemplated in different embodiments, wherein distance ‘d′’ may vary by up to and over 100 percent. Distance ‘b′’ may be approximately 9.625 inches, though other dimensions are contemplated in different embodiments, wherein distance ‘b′’ may vary by up to and over 100 percent.

FIG. 7B is a front elevation view of an exemplary embodiment of the grill legs 100 of the present invention.

FIG. 8A is a front elevation view of an exemplary embodiment of the grill support arm 200 of the present invention, shown without side bars 710.

FIG. 8B is a rear elevation view of an exemplary embodiment of the present invention.

FIG. 9A is a left-side elevation view of an exemplary embodiment of the main support arm 1100 of the present invention, and its constituent components: first member 1110, angled connector 1130, and the second member 1120, wherein the angled connector 1130 connects the first and second members 1110 and 1120. illustrating a plurality of holes 910 centered in the second member 1120. Distance ‘h′’ may be approximately 16.5 inches, though other dimensions are contemplated in different embodiments, wherein distance ‘h′’ may vary by up to and over 100 percent. Distance ‘i′’ may be approximately 36 inches, though other dimensions are contemplated in different embodiments, wherein distance ‘i′’ may vary by up to and over 100 percent. Distance ‘m′’ may be approximately 10 inches, though other dimensions are contemplated in different embodiments, wherein distance ‘m′’ may vary by up to and over 100 percent.

FIG. 9B is a front elevation view of an exemplary embodiment of the main support arm 1100 of the present invention.

FIG. 10A is a front elevation view of an exemplary embodiment of the present invention. Distance ‘q″’ may be approximately 9.25 inches, though other dimensions are contemplated in different embodiments, wherein distance ‘h′’ may vary by up to and over 100 percent. Distance ‘e′’ may be approximately 1.25 inches, though other dimensions are contemplated in different embodiments, wherein distance ‘e′’ may vary by up to and over 100 percent. Distance ‘r′’ may be approximately 6.25 inches, though other dimensions are contemplated in different embodiments, wherein distance ‘r′’ may vary by up to and over 100 percent.

FIG. 10B is a left-side elevation view of an exemplary embodiment of the present invention.

FIG. 10C is a right-side elevation view of an exemplary embodiment of the present invention.

FIG. 11 is a right-side elevation view of an exemplary embodiment of the main support arm 1100 of the present invention, and its constituent components: first member 1110, angled connector 1130, and the second member 1120, wherein the angled connector 1130 connects the first and second members 1110 and 1120.

FIG. 12 is a front elevation view of an exemplary embodiment of the present invention, shown in an installed condition.

FIG. 13 is a side elevation view of an exemplary embodiment of the present invention, shown in the installed condition.

FIG. 14 is a detailed side elevation view of an exemplary embodiment of the present invention, shown in the installed condition.

FIG. 15 is an exploded perspective elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a bracket for mounting a grill to a perimeter of the deck off the railing so that the footprint of the grill is not over the footprint of the deck.

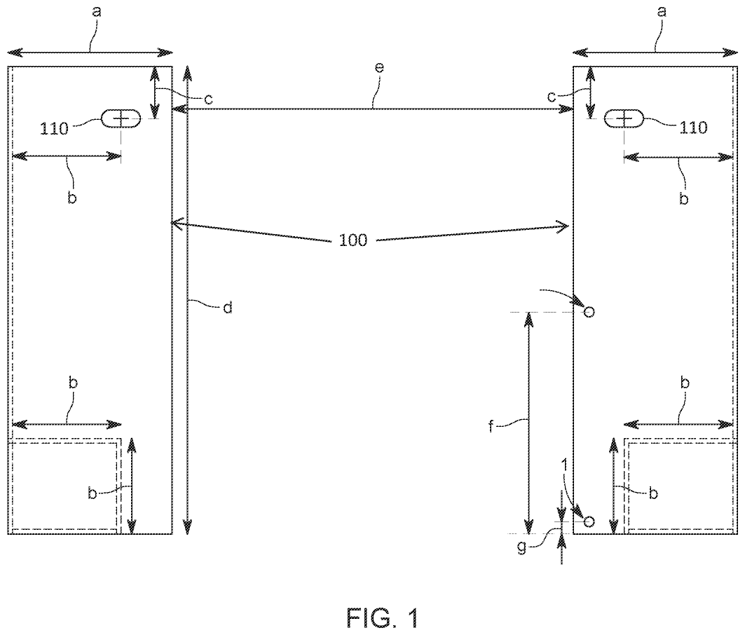

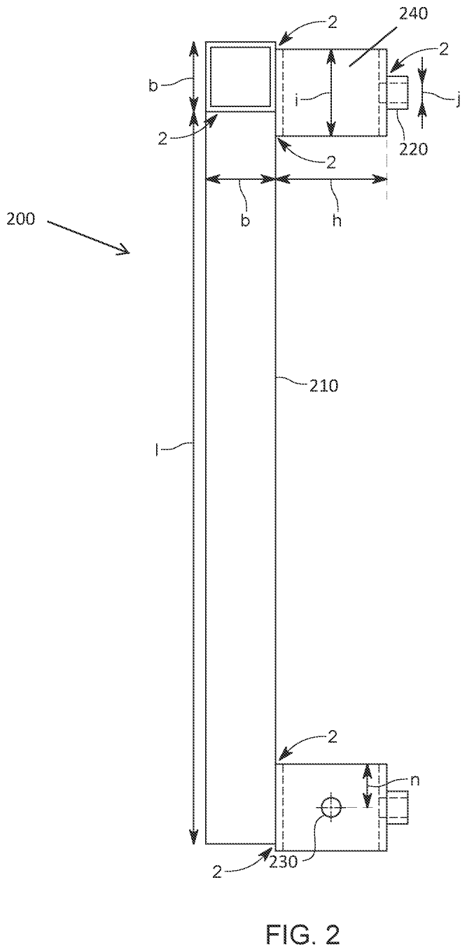

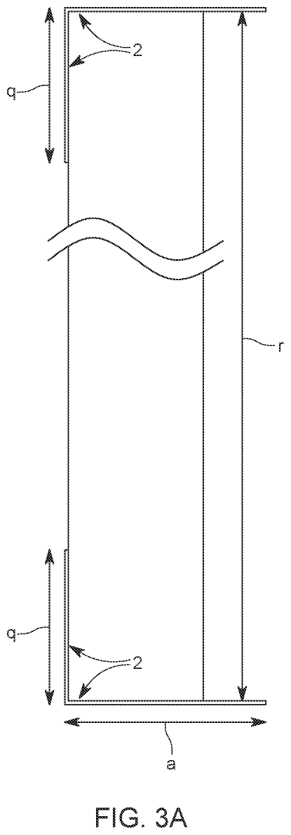

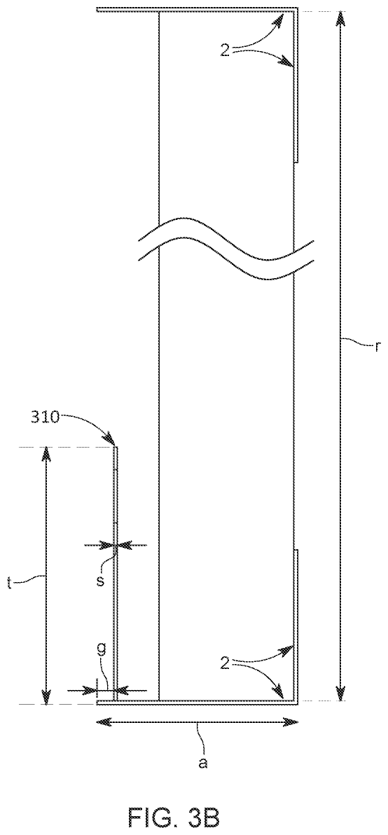

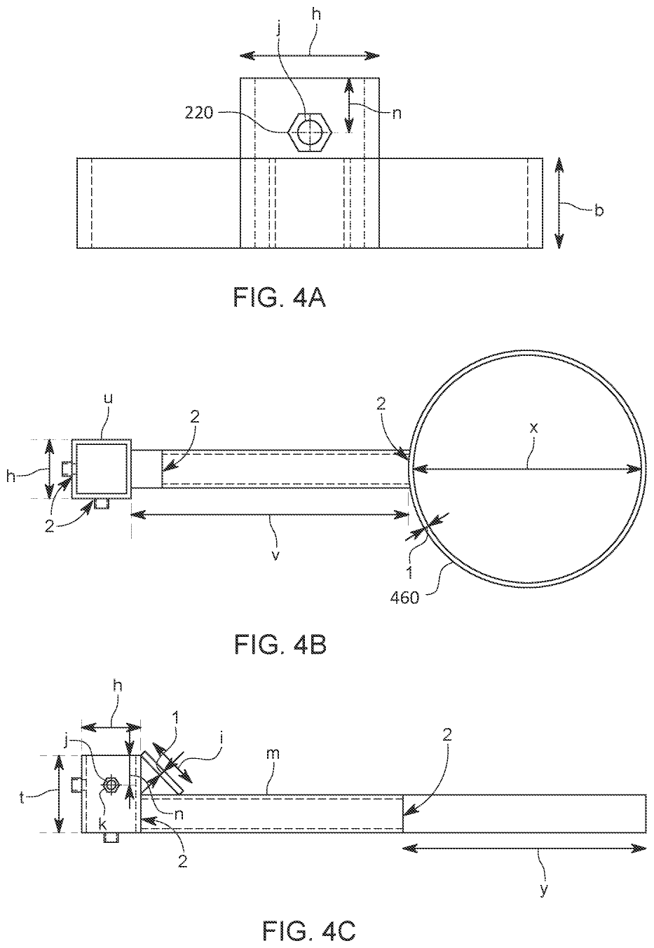

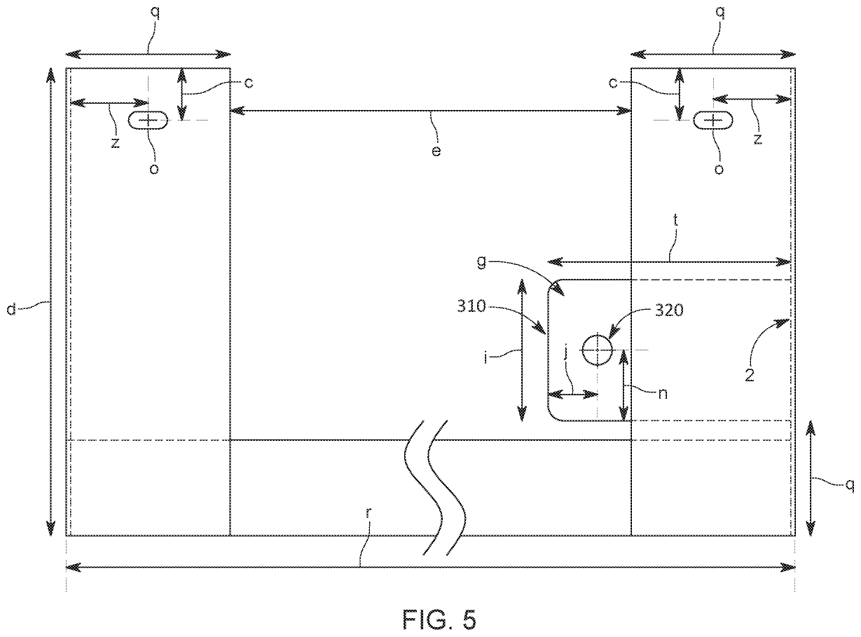

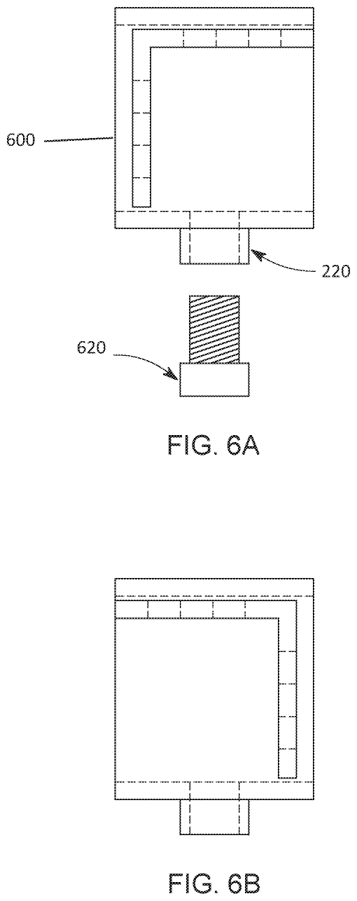

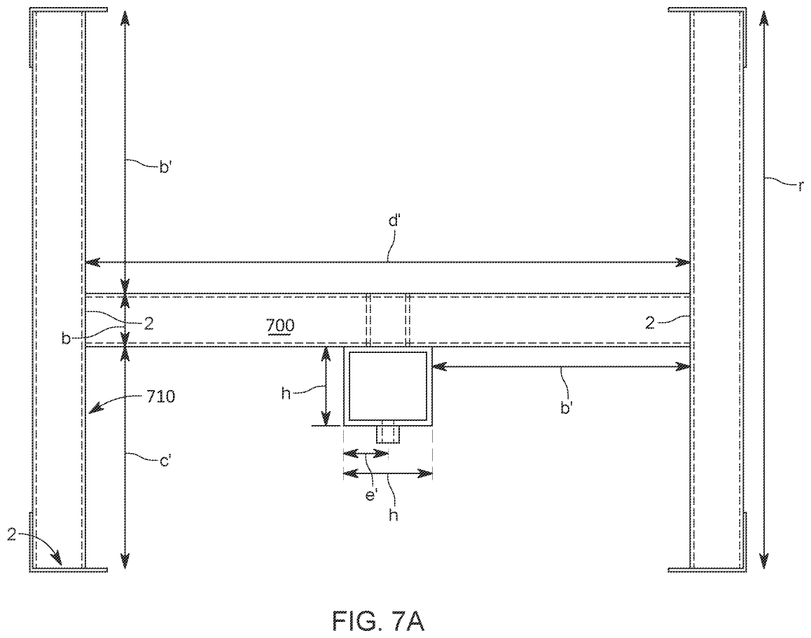

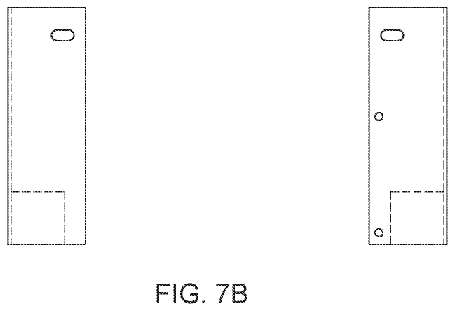

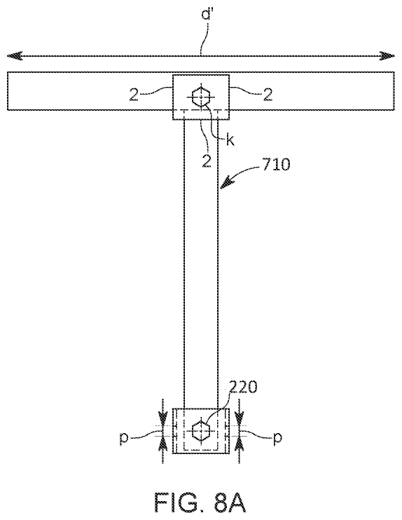

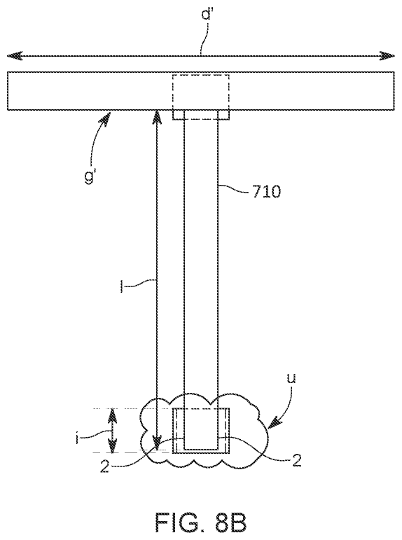

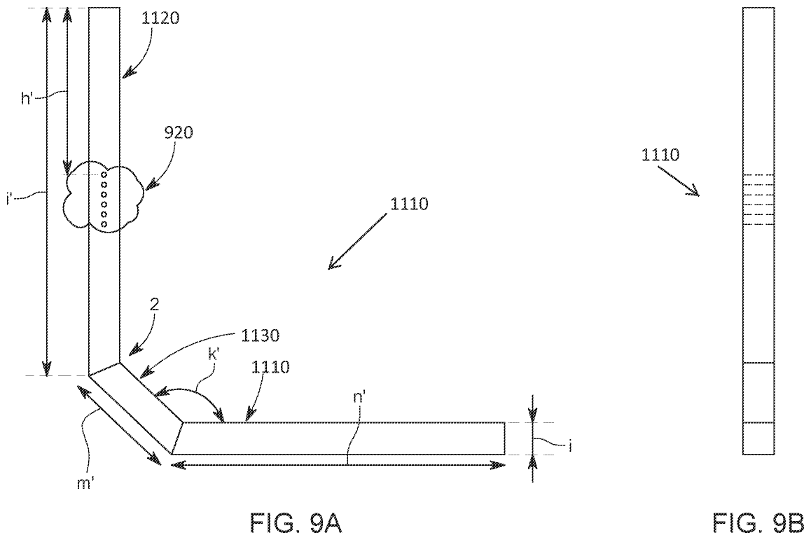

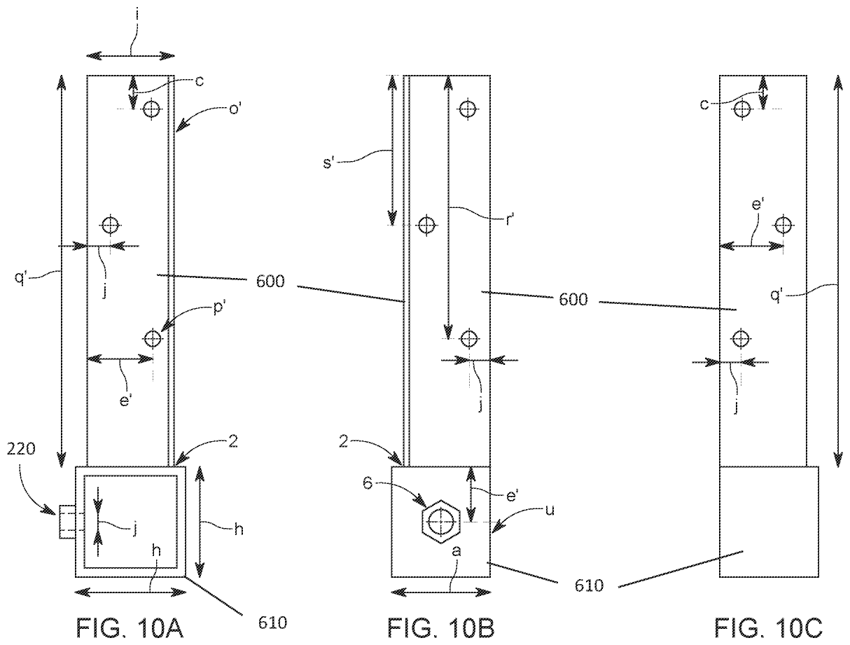

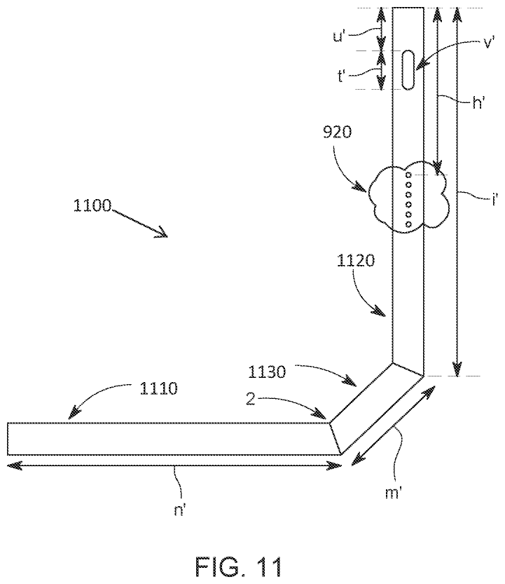

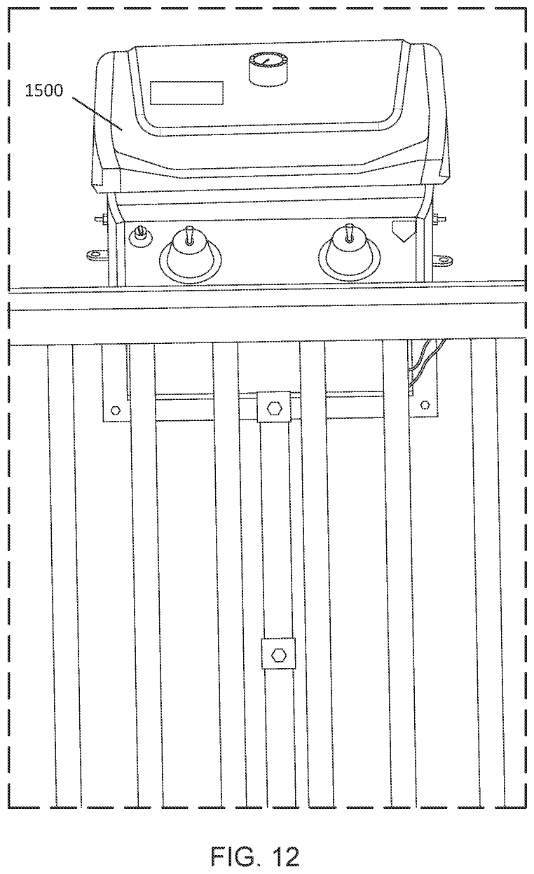

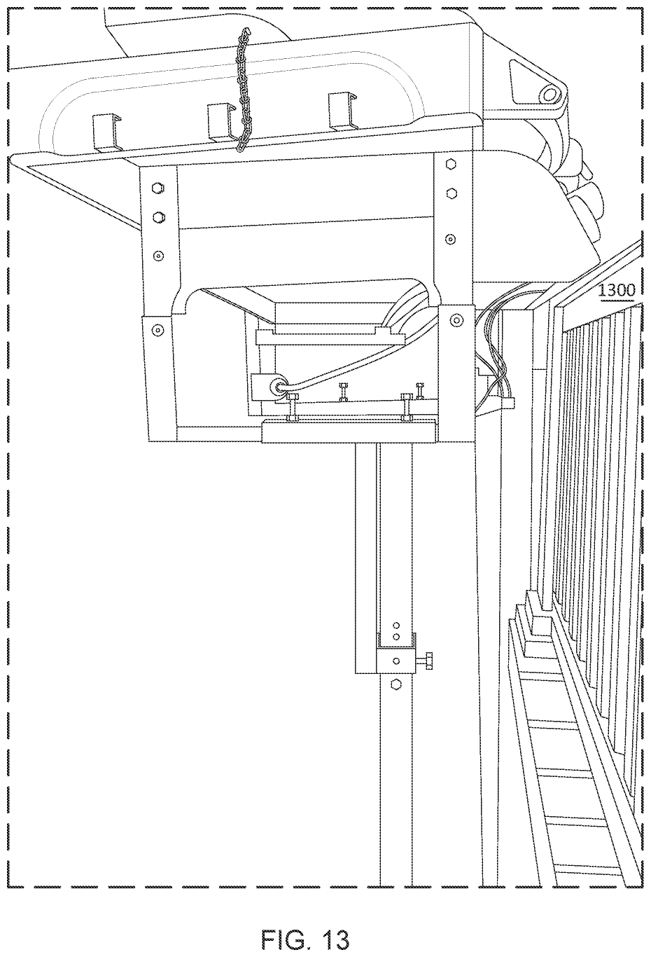

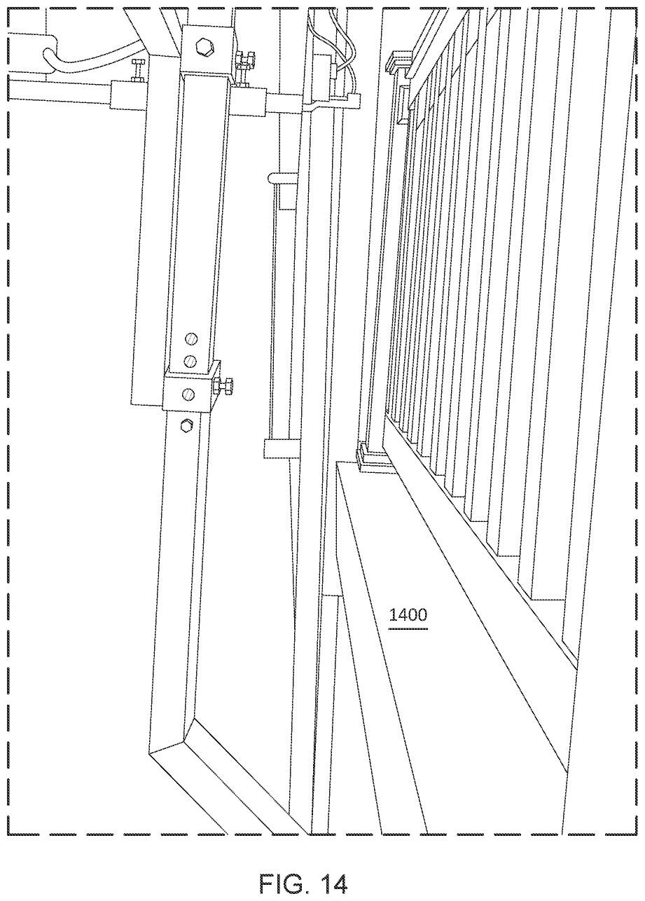

Referring now to FIGS. 1 through 15, the present invention may include the following components: grill support arm 200, grill legs 100 having tabs 310 to mount gas line bulkhead fittings, deck mounting bracket 600, main support Arm 1100, and LPG tank bracket 450. The components of this invention work together to securely support a barbecue grill to the perimeter of a deck or raised structure that is supported by the deck joists.

A method of making the invention includes the following steps:
Step 1 Choose the grill you would like to mount.
Step 2 Determine the mounting location on your deck.
Step 3 Determine which components of the grill stand will not be needed and remove the stand.
Step 4 Design grill mounting brackets to attach at the original locations to give the same or better support.
Step 5 Design deck mounting brackets that can be bolted to the joist whether they are perpendicular or parallel to the grill.
Step 6 The brackets must fit multiple size joists. The decking dictates the mounting height of the brackets.
Step 7 Determine the approximate height in distance from the railing 1300.
Step 8 Create a support arm between the deck and the grill with adjustment both horizontal and vertical.
Step 9 Create access to run a natural gas line securely to the grill.
Step 10 Fabricate grill mounting arms adjustable in length and width to mate between the support arm and the grill.
Step 11 Develop a way to mount a bulkhead fitting for a gas line and the ignitor to the grill arms.
Step 12 Put together a list of materials from the ruff drawing and order of needed supplies.
Step 13 Start cutting all the material to size. Correct the drawings as needed.

Some of the fabrication came “as built”.
Step 14 Locate a welder for the project.
Step 15 Provide the welder with the materials to begin the assembly process, tacking and fitting before final welding.
Step 16 Mount the deck brackets. Install the support arm and check to be sure it is plumb.
Step 17 Attached the grill support to the main mounting arm.
Step 18 Install the spreader arms and adjust the approximate width to the grill.
Step 19 Connect the grill legs to the spreader arms.
Step 20 Connect the grill legs to the grill, center it and tighten lock bolts.
Step 21 Mount the ignitor to the grill arm.
Step 22 Adjust the grill height in relation to the railing.
Step 23 Attach the gas line to the bulkhead fitting and check for leaks.
Step 24 Test the Grill

In one embodiment, the bracket system is a stainless-steel design configured to be adjustable both lengthwise and widthwise to fit different types of grills. Alternatively, the brackets can be replaced with fixed-length brackets (for instance the brackets would be made from carbon steel) for a single application. It is understood that the bracket systems can differ in materials, shapes, and size while still falling within the scope of the disclosure as long as the disclosed bracket system functions as described herein.

FIGS. 1-11 may refer to a fixed embodiment of the hanging grill bracket, wherein the connections between the components are fixed by welds or other fixed connection fasteners.

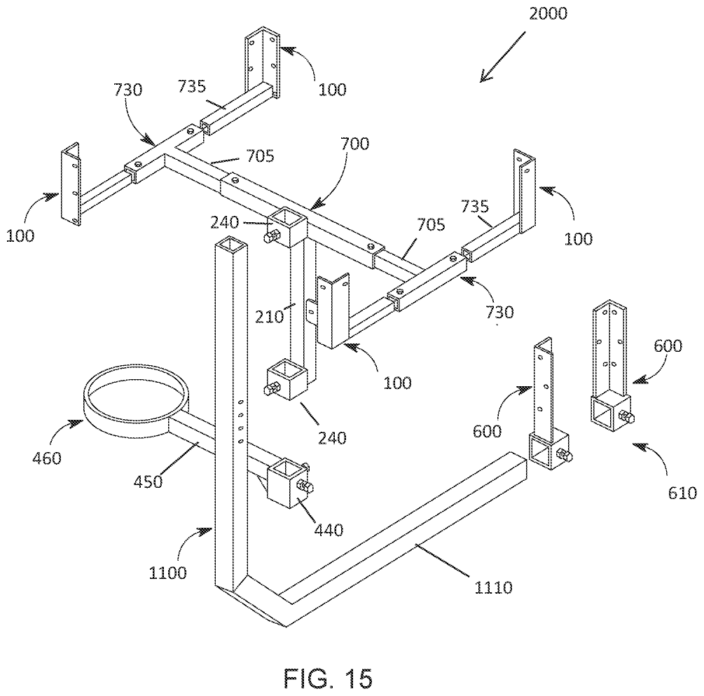

Referring to FIG. 15, the present invention provides an adjustable hanging grill bracket 2000. The adjustable hanging grill bracket 2000 has a main support arm 1110 that has a first member 1110 connected to a second member 1120 at approximately perpendicular orientation, relative to each other, by way of the interconnecting angled connector 1130. A proximal end of the first member 1110 may operatively associate with one or more deck mounting brackets 600 by way of collar connectors 610 dimensioned and adapted to be adjustable slide along a length of the first member 1110 so as to be fixed thereto by way of one or more fasteners, such as lock bolts 620. Each deck mounting brackets 600 may have an angle bracket or channel for attaching to the underside of the deck 1400 and the joists thereof, depending on the joist types.

A midportion of the second member 1120 may provide a plurality of spaced apart attachment holes 920 so that a gas tank bracket 450 can selectively connect to one of the plurality of attachment holes 920. The distal end of the gas tank bracket 450 may provide a circular or arcuate band 460 for circumscribing the gas tank, though other shapes are incorporated herein. The proximal end of the gas tank bracket 450 may provide a collar connector 440 for sliding along the length of the second member 1120. It is understood that other forms of adjustable or movable connectors could be provided, as opposed to the collar connections, though the ability to slide along a longitudinal member while also circumscribing that member provides a level a security sought after when cantilevering a grill 1500 off a deck 1400.

A grill support arm 200 can be connected to the second member 1120 of the main support arm 1100 by the way of collar connectors 240 and fasteners 220. The grill support arm 200 may have a main arm 210 with a collar connector 240 at each end thereof, wherein the collar connectors 240 can selectively attach along the second member 1120, thereby making it adjustable, in an orientation perpendicular to the gas tank bracket 450.

The distal/upper collar connector 240 of the main arm 210 may attach to an adjustable crossbar 700 that provides a sleeve through which adjustable, telescopically connected extendable crossbars 705 may slide from both ends and lock at a selected location, relative to the adjustable crossbar 700, by way of fasteners. The distal ends of the extendable crossbars 705 may end in a perpendicular adjustable T-section 730. Much like the adjustable crossbar 700, the adjustable T-section 730 may be a sleeve through which adjustable, telescopically connected extendable side bars 735 may slide from both ends, relative to the adjustable T-section 730, and lock at a selected location by way of fasteners. Perpendicularly extending from the distal ends of the extendable side bars 735 may be grill legs 100 to support the grill 1500. One or more gill leg 100 may have a gas line mount 310.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of hanging a grill off a railing of a deck, so that the grill hangs off the railing, projecting beyond a footprint of the deck, the method comprising:
connecting a main support arm to an underside of the deck so that a distal portion of the main support arm extends above and perpendicular relative to a decking of the deck;
selectively connecting a grill support arm from the distal portion of the main support arm;
adjusting a length of an adjustable crossbar that is joined to a distal end of the grill support arm, wherein the adjustable crossbar provides adjustable side bars extending from opposing ends of the adjustable crossbar, and wherein a respective grill leg extends perpendicularly from each end of the adjustable sidebars; and
connecting the grill to the respective grill legs so that the grill projects above and beyond a footprint of the decking.

2. The method of claim 1, wherein a gas tank bracket extends from the distal portion in a direction perpendicular to the grill support arm.

3. A bracket system for hanging a grill off a railing of a deck, so that the grill hangs off the railing, projecting beyond a footprint of the deck, the bracket system comprising:
a main support arm extending between a proximal end and a distal portion wherein the proximal and distal portions are oriented perpendicular to each other;
a grill support arm selectively sliding along the distal portion of the main support arm;
an adjustable crossbar connected to a distal end of the grill support arm, wherein the adjustable crossbar has telescopic extendable crossbars, one telescopic extendable crossbar extending from each end thereof;
an adjustable side bar connected to each distal end of each telescopic extendable crossbars, wherein each adjustable side bar has telescopic extendable side bars, one telescopic extendable side bar extending from each end thereof, wherein the adjustable side bar and adjustable crossbar are coplanar; and
legs extend perpendicularly from each adjustable extendable side bars.
